(19) United States
(12) Patent Application Publication
(10) Pub. No.: US 2025/0186174 A1
(43) Pub. Date: Jun. 12, 2025

(54) METHOD FOR USING DIGITALLY DESIGNED DEVICES TO CAPTURE FIT AND TOOTH POSITION INFORMATION FOR THE PARTIALLY OR FULLY EDENTULOUS PATIENT

(71) Applicant: Keith E. Gibson, Oklahoma City, OK (US)

(72) Inventor: Keith E. Gibson, Oklahoma City, OK (US)

(21) Appl. No.: 18/979,119

(22) Filed: Dec. 12, 2024

Related U.S. Application Data
(60) Provisional application No. 63/609,042, filed on Dec. 12, 2023.

(51) Int. Cl. A61C 13/00; A61C 9/00; A61C 13/01

(52) U.S. Cl. CPC A61C 13/0004; A61C 9/0046; A61C 13/0019; A61C 13/01

(57) ABSTRACT

A method of capturing fit and tooth position information for creating a full arch prosthesis by forming the maxillary base plate with the occlusal rim having an anterior segment, a pair of posterior segments, a plurality of horizontal reference lines vertically spaced relative to one another corresponding with the average length of the clinical crown of upper central incisors, and a plurality of shim members connectable to the anterior segment. The position of the patient's smile is evaluated relative to a selected reference line of the maxillary base to obtain a desired position of an upper incisal edge represented by a lower surface of the anterior segment. If the position of the upper incisal edge is not satisfactory, a shim member is connected to the lower surface of the anterior segment, and the position of the patient's smile is reevaluated.

### INCORPORATION BY REFERENCE

The present application claims priority to a provisional patent application identified by U.S. Ser. No. 63/609,042, filed on Dec. 12, 2023, titled “Method for Using Digitally Designed Devices to Capture Fit and Tooth Position Information for the Partially or Fully Edentulous Patient,” the entire contents of which are hereby incorporated herein by reference.

### BACKGROUND

In the dental field of removable prosthodontics, to predictably create a quality prosthesis, it is necessary to take high-quality, accurate impressions and gather certain anatomical dimensional measurements from the patient's intraoral and extraoral anatomy. Specifically, the placement of denture teeth is generally understood to be improved when inputting these anatomical and dimensional measurements that are customized so that the final prosthesis is in harmony with the patient's face and temporomandibular joint.

Some dimensional measurements recognize the position of the interdental papilla. Additional dimensional measurements are the width of the nose and, specifically, the interalar width. Other measurements that are helpful for placing denture teeth are using the face to evaluate the aesthetic relationship of the maxillary and mandibular anterior teeth, for the vertical dimension and horizontal plane used to determine the optimal denture teeth arrangement/positions.

Such measurements play a prominent role in the analog method of removable prosthetic tooth placement. Digital scanning and CAD-CAM technology have made significant advances toward alternative options to replace the conventional gathering of critical information to create a removable dental prosthesis. Digital design of dentures accomplished through CAD-CAM technology, which may involve additive manufacturing or milling to make dentures, is rapidly progressing.

Several techniques exist to manage the workflow of a patient seeking removable dental prosthetic treatment: a combination of conventional and digital techniques, the use of a reference denture along with digital techniques, or, of course, an all-conventional technique.

Managing a patient's time with a dental professional is a delicate balance. It must be ensured that the time is effectively spent acquiring all the necessary information to deliver a highly accurate, fully functional final prosthesis.

There exists a need for a method to gather information for an edentulous patient to produce a prosthesis that involves greater accuracy and less chairside time for both the patient and the dental professional. There is a further need to integrate critical patient measurements/anatomical information into a fully digital workflow that improves dental techniques for creating digital or conventional dentures. This CAD-CAM approach significantly enhances and simplifies dentist-guided aesthetic and functional objectives. There is an even further need to provide seamlessly communicated information to the dental technician that aids in creating a prosthesis, such as a denture, with optimal quality and predictability.

### SUMMARY OF THE INVENTIVE CONCEPTS

In one aspect, the inventive concepts disclosed herein are directed to a method of capturing fit and tooth position information for creating a full arch prosthesis by digitally forming a maxillary base plate with a monolithic occlusal rim and a mandibular plate with a monolithic occlusal rim. The maxillary base plate has an anterior segment, a pair of posterior segments, a plurality of horizontal reference lines vertically spaced relative to one another corresponding with the average length of the clinical crown of upper central incisors, and a plurality of shim members connectable to the anterior segment. The position of the patient's smile is evaluated relative to a selected reference line of the maxillary base to obtain a desired position of an upper incisal edge represented by a lower surface of the anterior segment. If the position of the upper incisal edge is not satisfactory, a shim member is connected to the lower surface of the anterior segment, and the position of the patient's smile is reevaluated.

### BRIEF DESCRIPTION OF THE DRAWINGS

FIG. 1 is an occlusal view of a patient's maxillary arch illustrating a plurality of anatomical landmarks.

FIG. 2 is a facial view of a measurement of a patient's potential incisocervical position of the maxillary central incisor with a lip at rest.

FIG. 3 is a facial view of an instrument used to record the interalar dimension of a patient at a smile.

FIG. 4 is an exploded, top perspective view of a maxillary base plate and occlusal rim constructed in accordance with the inventive concepts disclosed herein.

FIG. 5 is an exploded, occlusal perspective view of the maxillary base plate and occlusal rim of FIG. 4.

FIG. 6 is an occlusal plan view of the maxillary base plate and occlusal rim.

FIG. 7 is an occlusal plan view of a mandibular base plate and occlusal rim constructed in accordance with the inventive concepts disclosed herein.

FIG. 8 is a perspective view of the maxillary base plate and occlusal rim with a plurality of shim members connectable thereto.

FIG. 9 is a facial elevational view of the maxillary base plate and occlusal rim of FIG. 8 with the shims members connected thereto.

FIG. 10 is an occlusal plan view of the mandibular base plate and occlusal rim of FIG. 7 with a plurality of shim members connectable thereto.

FIG. 11 is a facial elevational view of the mandibular base plate and occlusal rim with the shims members connected thereto.

FIG. 12 is a lateral view of the maxillary base plate and occlusal rim and the mandibular base plate and occlusal rim illustrating maxilla-mandibular relation in centric relation.

### DETAILED DESCRIPTION OF EXEMPLARY EMBODIMENTS

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. The inventive concepts disclosed herein are capable of other embodiments or being practiced or carried out in various ways. Also, it is to be understood that the phraseology and terminology employed herein are for the purpose of description and should not be regarded as limiting the inventive concepts disclosed and claimed herein in any way.

In the following detailed description of embodiments of the inventive concepts, numerous specific details are set forth in order to provide a more thorough understanding of the inventive concepts. However, it will be apparent to one of ordinary skill in the art that the inventive concepts within the instant disclosure may be practiced without these specific details. In other instances, well-known features have not been described in detail to avoid unnecessarily complicating the instant disclosure.

As used herein, the terms “comprises,” “comprising,” “includes,” “including,” “has,” “having,” and any variations thereof are intended to cover a non-exclusive inclusion. For example, a process, method, article, or apparatus that comprises a list of elements is not necessarily limited to only those elements and may include other elements not expressly listed or inherently present therein.

Unless expressly stated to the contrary, “or” refers to an inclusive or not an exclusive or. For example, a condition A or B is satisfied by any one of the following: A is true (or present), and B is false (or not present), A is false (or not present), and B is true (or present), and both A and B is true (or present).

In addition, the use of the “a” or “an” is employed to describe elements and components of the embodiments disclosed herein. This is done merely for convenience and to give a general sense of the inventive concepts. This description should be read to include one or at least one, and the singular should also include the plural unless it is obvious that it is meant otherwise.

As used herein, qualifiers like “substantially,” “about,” “approximately,” and combinations and variations thereof, are intended to include not only the exact amount or value they qualify, but also some slight deviations therefrom, which may be due to manufacturing tolerances, measurement error, wear and tear, stresses exerted on various parts, and combinations thereof, for example.

Finally, as used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

One aspect of the inventive concepts disclosed herein is a method and system that gathers critical post-extraction information to produce a well-fitting, aesthetically pleasing, and optimally functioning full arch or full mouth prosthesis, either removable or affixed by implants. A quality prosthesis is dependent upon accurately gathering the information, such as accurate patient intra-oral anatomy for optimal fit, incisal edge position of upper and/or lower central incisors, vertical dimension of occlusion (VDO), occlusal plane, maxilla-mandibular relation in centric relation (CR), and verification of the accuracy of information gathered.

The inventive concepts disclosed herein entail producing a custom base plate and occlusal rim through CAD-CAM technology that efficiently and accurately assists in gathering this information. During a first patient visit, the dental practitioner will gather needed data from the patient by utilizing anatomical measurements and data derived from patient anatomy. In a first embodiment, the digital data may comprise final impressions of the patient's intra-oral anatomy. In a second embodiment, the dental practitioner may take an intra-oral scan of the patient, focusing primarily on the ridges of the upper and lower arches but ideally also mapping the vestibular regions of the patient's intra-oral anatomy. In other embodiments, the patient's existing denture or other prosthesis may be used for scanning, or other methods for acquiring data for existing patient oral anatomy may be used. However, when the patient's intra-oral anatomy is captured, scanned, or acquired, the digital data that results may be characterized as a first set of digital data.

Regarding the intra-oral scan, many of the current scanner heads have a small field of view and corned edges, rendering them unable to reliably image the mucosa of the vestibular regions of the intra-oral anatomy. It is certainly not an objective of most intra-oral scanners to map those regions of the patients, especially with the mandible, where the tongue and other obstructions create impediments to such a full scan. In an embodiment of the invention, a probe for an intra-oral scanner head is utilized with the inventive method, the probe having a rounded head or curved aspects thereof. In another embodiment, a wide field of view for the probe of the scanner head is disclosed with this embodiment of the inventive method.

The impression may be acquired through several techniques known in the art. Impression trays, as described below, may be utilized in an embodiment of the invention. The impression material may be used as understood in the arts for being appropriate for standard impression material, rigid setting impression material for border molding, and fast setting material for the final impression. Other impression materials may be utilized within the scope of the invention.

Maxillary and mandibular trays may be shaped according to embodiments of the invention by placing the trays in the patient's mouth and shaping them to the patient's palate and alveolar ridge using border molding techniques.

The trays may be evaluated and modified by trimming them with a cutting tool, adding material, or stretching the tray. Further, the tray may be perforated with open tray implant impressions. After modifications, an adhesive may be applied to the tray, with border molding applied to the maxillary and mandibular trays. Relief may be applied to areas of the impression tray that show thinning of PVS material by using a carbide bur or other tools known in the arts to remove such pressure point areas. At this point, maxillary and mandibular impressions may be made and scanned by methods well-known in the arts for mapping out the complete dimensions of an upper and/or lower arch impression to input into the first digital data set.

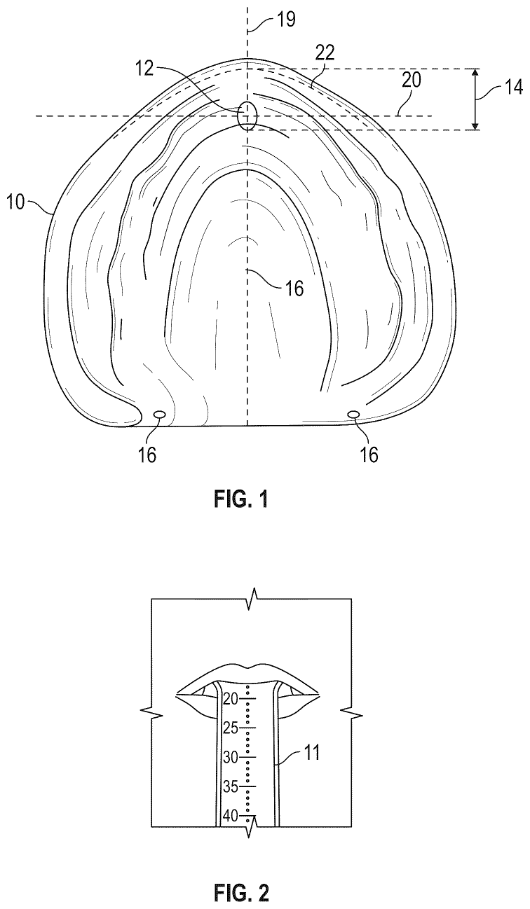

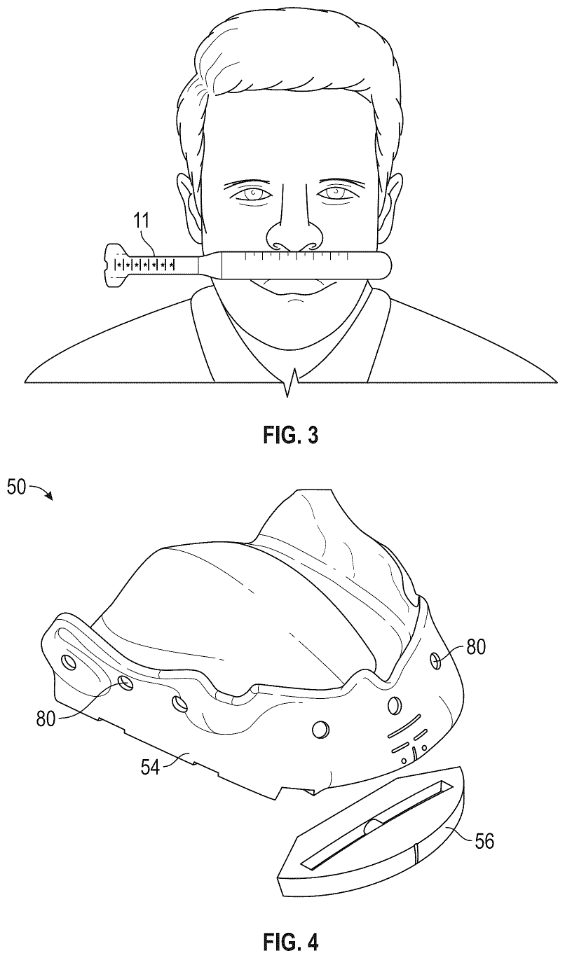

Referring now to the drawings, and more particularly to FIGS. 1-3, during the first patient visit, certain anatomical measurements/landmarks may be noted and measured on a patient's maxillary arch 10 using a papillameter 11 (FIGS. 2 and 3), for example. Some measurements include a midline of the incisive papilla 12, a posterior border of the incisive papilla 14, a center of the palate 16, and hamular notches 18. As discussed below, these points may be used to create a horizontal plane to construct a custom base plate with an occlusal rim. Initially, anatomical landmarks may be recorded and utilized on the maxillary record. The midline of the incisive papilla 12 and the center of the palate 16, as defined by palatine raphe points, create an anteroposterior reference axis 19. A mediolateral axis 20 may intersect with a midline of the incisive papilla 12 and be perpendicular to the anteroposterior axis 19, creating the resulting mediolateral axis 20. The interalar measurement determines the most lateral extension of the mediolateral axis 20 and aids in determining right and left canine landmarks, which are utilized for referencing the arch form for the custom maxillary base plate and occlusal rim.

The labial surface position of the maxillary central incisor may be created using the anteroposterior axis 19 at the midline. The most anterior extension of this measurement is determined by measuring 11 mm to 12 mm along this measurement anteriorly from the posterior border of the incisive papilla 12. This determines the position of the labial surface of the incisal ⅓ of the central incisor. An arch 22 may then be determined by connecting the most anterior extension of the anterior-posterior plane and the mediolateral axis 20 and the most lateral extension of the mediolateral axis 20 to be used as a guide along with arch form to build an aesthetic arc of curvature.

Mediolateral orientation of the maxillary occlusal rim may be made horizontal by a reference line connecting the right and left hamular notches 18 and incisive papilla 12 that align parallel to the XY plane in a patient coordinate system utilized in design software. The mandibular occlusal plane uses three reference points on the mandibular arch: the left center retromolar pad, the right center retromolar pad, and the desired incisal edge position of the mandibular central incisor.

The vertical position of the anterior segment of the custom occlusal rim is based on the reading of the papillameter 11 (FIG. 2) with the patient's lip at rest position. A mediolateral orientation of the anterior segment of the upper custom occlusal rim is created to be parallel to the determined horizontal plane and perpendicular to the anterior-posterior plane. FIG. 2 shows a measurement of a patient's lip at rest to aid in determining the starting position of the incisal edge of the maxillary central incisor. FIG. 3 depicts a facial view of the papillameter 11 being utilized to record the interalar dimension of a patient.

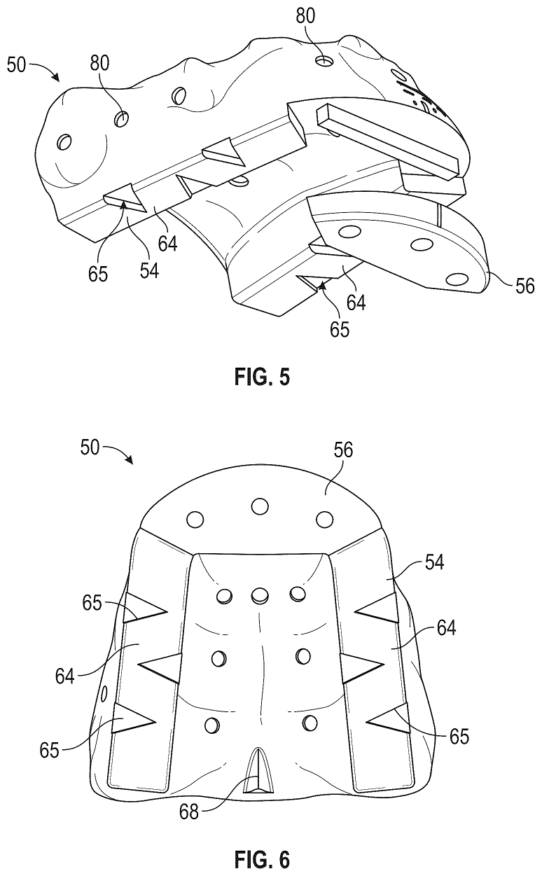

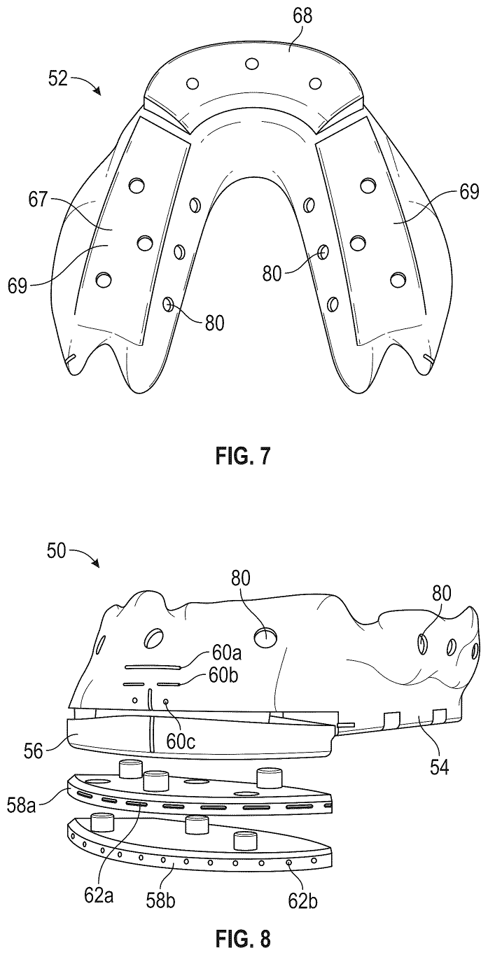

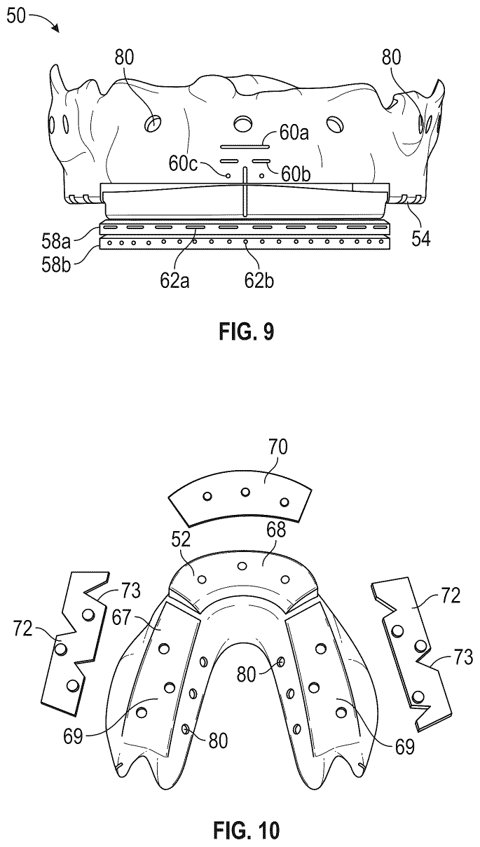

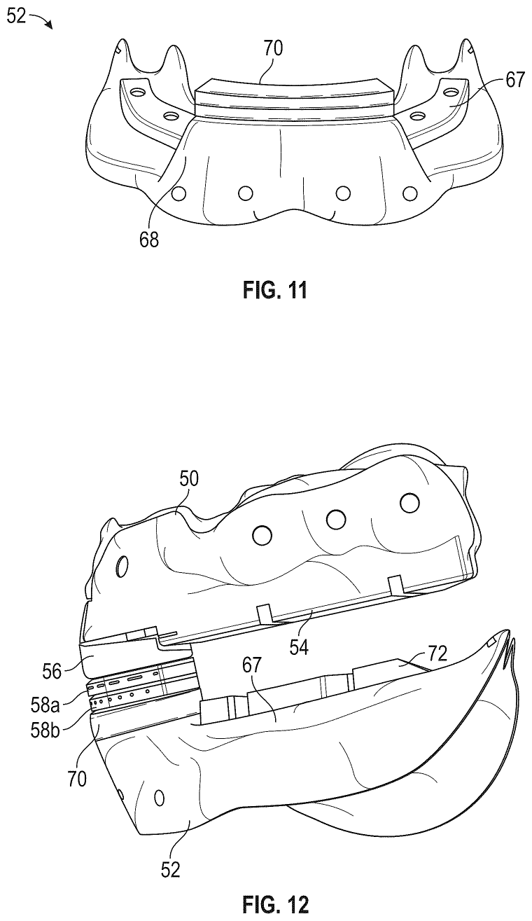

The data from the first patient interaction results in the first set of digital data from which a custom maxillary base plate 50 (FIGS. 4-6) and a custom mandibular base plate 52 (FIG. 7) are created using CAD-CAM technology. With the above references created and mapped, the resulting data may be converted to a three-dimensional electronic model of a maxillary base plate 50 and the mandibular base plate 52, which are then milled or otherwise formed. In one embodiment, the digital data may be created in one software and imported into a different software for creating the base plates 50 and 52. In other embodiments, the same tasks may be accomplished within one software program across one computing system or several platforms attended to by one or more technicians. Once formed, the base plate 50 and the base plate 52 can be modified at a second patient interaction, as discussed below.

The maxillary base plate 50 is a rigid or semi-rigid foundation formed to mate with the patient's maxillary arch 10. The base plate 50 includes an occlusal rim 54 formed monolithically with the base plate 50. The base plate 50 may further include an anterior segment 56 and a plurality of shim members 58a and 58b. The anterior segment 56 is a part of the occlusal rim 54. It may be pivotally connected to the base plate 50 to allow an occlusal or lower surface of the anterior segment 56 to adjust horizontally relative to the base plate 50 should the patient's anatomical features not be horizontal. As discussed above, the most anterior position of the anterior segment 56 is formed at approximately 11-12 mm anterior to the posterior border of incisive papilla 12 (FIG. 1) along the line determining the anterior-posterior axis 19.

The shim members 58a and 58b are block structures connectable to the occlusal rim 54. The shim members 58a and 58b are used to establish the vertical or incisal edge position of upper and lower anterior occlusal rims during the second patient interaction. The shim members 58a and 58b may have a thickness of 2 mm, but it will be appreciated that the thickness can be varied. As shown in FIG. 8, the shim members 58a and 58b are contoured to conform to the shape of the arch of the anterior segment 56 to which they are to be connected. In one embodiment, the shim members 58a and 58b connect to the occlusal rim 54 using a pin/hole attachment. It will be appreciated that various means of connecting the shim members 58a and 58b to the occlusal rim 54 may be implemented.

The anterior segment 56 of the base plate 50 may have a plurality of reference lines 60a, 60b, and 60c vertically spaced at a distance (e.g., 10 mm). Each of the reference lines 60a, 60b, and 60c differs from one another in form. For example, the reference line 60a is a solid line, the reference line 60b is a dash-dash line, and the reference line 60c is a dot-dot line. The lower surface of the anterior segment 56 corresponds to the reference line 60a. The shim member 58a may include a reference line 62a corresponding to the reference line 60b (i.e., dash-dash), and the shim member 58b may include a reference line 62b corresponding to the reference line 60c (i.e., dot-dot). The shim members 58a and 58b may be configured to connect to the anterior segment 56 in a specific order. For example, the shim member 58a may be configured to connect to the anterior segment 56, and the shim member 58b may be configured to connect to the shim member 58a but not to the anterior segment 56.

The base plate 50 further has a pair of posterior segments 64. The posterior segments 64 of the occlusal rim 56 may have triangular notches 65 to aid in bite or interocclusal record accuracy.

The maxillary base plate 50 has an inverted “shark fin” or protrusion 68 (FIG. 6) located at the intersection of the midline and posterior border of the base plate 50. The protrusion 68 is used in gathering the maxillo-mandibular relation or bite in centric relation (CR) by having the patient relax their lips and take the tip of the tongue up and back to locate the shark fin 68 now placing bite registration material aids in gathering optimal maxilla-mandibular relation or interocclusal record in centric relation (CR).

The mandibular arch of the patient (not shown) is positioned using both midline/incisal edge reference points from the maxillary and mandibular arch. The mandibular midline/incisal edge reference point is positioned to the maxillary midline/incisal edge.

Like the maxillary base plate 50, the mandibular maxillary base plate 52 (FIG. 7) is a rigid or semi-rigid foundation formed to mate with the patient's mandibular arch. The base plate 52 is formed to include an occlusal rim 67 formed monolithically with the base plate 52. The base plate 52 may include an anterior segment 68, a pair of posterior segments 69, and a plurality of shim members 70 and 72. The anterior segment 68 is a part of the occlusal rim 67.

The shim members 70 are similar to the shim members 58a and 58b discussed above. The shim members 70 are used to establish the vertical or incisal edge position of the occlusal rim 67 during the second patient interaction. The shim members 70 have a thickness of 2 mm, but it will be appreciated that the thickness can be varied. As shown in FIG. 10, the shim members 70 are contoured to conform to the shape of the arch to which they are connected. In one embodiment, the shim members 70 connect to the occlusal rim 67 using a pin/hole attachment. It will be appreciated that various means of connecting the shim members 70 to the occlusal rim 67 may be implemented.

The shim members 72 connect to the posterior segments 69 of the occlusal rim 67. The shim member 72 may reduce the gap between the occlusal rim 56 of the base plate 50 and the occlusal rim 67 to reduce the amount of bite registration material required when capturing the bite or interocclusal record. The shim members 72 may have triangular notches 73 to hold the bit material when capturing the bite or interocclusal record.

The second patient interaction includes seating the maxillary base 50 and the mandibular base plate 52. The fit of the base plates 50 and 52 is first evaluated and, if not satisfactory, is modified by border molding and perforating through dimples 80 on the base plates 50 and 52 to become customized trays for a final impression.

To obtain this incisal position, the dentist or trained assistant may remove or add the shim members 58a and 58b and the shim members 70 to the anterior segments of the occlusal rim at the second patient interaction or “records” appointment. Optionally, the shim members 72 may be removed or added to the posterior segments 69 of the occlusal rim 66 to more closely approximate the position of the anterior-posterior occlusal plane.

The smile greatly influences the incisal edge position of the anterior segment 56 of the maxillary base plate 50. At this seating of the maxillary base plate 50, when determining the upper central incisor position, the patient smiles, and if the reference line 60a is not visible, the shim member 58a is connected to the anterior segment 56. If, after reevaluating, the reference line 60b is not visible, the incisal position is established by the lower end of the shim member 58a. If, after reevaluating, the reference line 60b is visible, the shim member 58b is connected to the shim member 56a. If, after reevaluating, the reference line 60c is not visible, the incisal position is established by the lower end of the shim member 58b. If both of the shim members 58a and 58b are removed and the reference line 60a is visible at the smile, the dentist or trained assistant can mark a high lip line above the reference line 60a. Otherwise, once the patient smiles and the corresponding reference line is not visible, the incisal edge position is now established on the maxillary base plate 50.

It will be appreciated that when determining the upper central incisor position, the shim members 58a and 58b may be initially connected to the anterior segment 56 and then sequentially removed as determined to be necessary rather than sequentially added as described above.

For the lower incisal position, the shim members 70 are removed or added until about the same level of lip is at rest. The posterior segments 69 of the occlusal rim 67 begin at the inferior border of the retromolar pad and remain level to the most distal extension of the anterior segment 68 of the occlusal rim 67. The shim member 72 (e.g., 2 mm in height) may be added to the posterior segments 69 to bring the occlusal rim 67 inferior but in close proximity to the line on a lateral border of the base plate 52 denoting the center of the retromolar pad. At this point, a bite or interocclusal record is taken by capturing the maxillo-mandibular relationship in centric relation.

The gathering of the maxillo-mandibular relationship (FIG. 12) is accomplished by having the patient take the tip of the tongue up and back to locate the projection 68 (FIG. 6) that is inferiorly oriented and positioned at the intersection of the midline and posterior border of the maxillary base plate 50. With the tongue or genioglossus muscle in this position, the patient is guided to relax all other peri-oral and intra-oral muscles and to close until there is a first contact point. This contact point should occur on the anterior segment 56 of the maxillary base plate 50 and the anterior segment 68 of the mandibular base plate 52. Placing bite or interocclusal registration material on the posterior segments 69 of the base plate 52 and the patient's tongue up and back, closing gently until first contact will register maxillo-mandibular relationship or centric relation CR at established VDO.

The base plates 50 and 52 are removed from the mouth and, while affixed by the interocclusal records, are scanned, forwarded, and seamlessly communicated to the lab technician. The laboratory is acutely aware of managing this data, thereby optimizing communication and creating this seamless collaboration of information used to create a digitally designed or conventional try in denture. This try-in denture is returned to the dentist or trained assistant for the third patient interaction at which verification of the accuracy of critical information is evaluated: fit, the incisal position of upper and/or lower central incisors (i.e., aesthetics, phonetics), vertical dimension of occlusion (VDO), occlusal plane-anteriorposterior and mediolateral, and maxillo-mandibular relation in centric relation (CR) (i.e., posterior occlusion).

If all criteria are correct, the prosthesis will be returned to the laboratory and finalized for delivery at the fourth patient interaction. One or several of these criteria must often be modified (i.e., occlusion, aesthetics). If so, the required data is collected (i.e., new bite, new incisal edge position) and returned to the laboratory for correction. This will result in the fourth patient interaction to try a modified denture and verify that the corrections are accurate. If so, the laboratory will finalize, and the denture will be returned to the dentist for delivery at the fifth patient interaction. If discrepancies still exist at the fourth patient interaction, the protocol necessary at the second patient interaction or records appointment should be reviewed. The dentures are usually verified to be accurate and seated no later than the fifth patient interaction. These devices and techniques are about efficiency, accuracy, and verification, which, when the protocol or method is used correctly and followed, will result in consistently creating a prosthesis that requires only minor follow-up care.

From the above description, it is clear that the inventive concepts disclosed and claimed herein are well adapted to carry out the objectives and attain the advantages mentioned herein and those inherent in the invention. While exemplary embodiments of the inventive concepts have been described for purposes of this disclosure, it will be understood that numerous changes may be made that will readily suggest themselves to those skilled in the art and which are accomplished within the spirit of the inventive concepts disclosed and claimed herein.

What is claimed is:

1. A method of capturing fit and tooth position information for creating a full arch prosthesis, the method comprising:
obtaining a three-dimensional electronic model of a patient's maxillary and mandibular arch and measuring the patient's intra-oral anatomy and extra-oral anatomy to produce a first data set;
converting, by a computer processor, the first data set to a three-dimensional electronic model of a maxillary base plate with an occlusal rim;
forming the maxillary base plate with the occlusal rim having an anterior segment, a pair of posterior segments, a plurality of horizontal reference lines vertically spaced relative to one another corresponding with the average length of the clinical crown of upper central incisors, and a plurality of shim members connectable to the anterior segment;
seating the maxillary base plate on the maxillary arch of the patient;
evaluating the fit of the maxillary base plate and, if not satisfactory, modifying the fit of the maxillary base plate;
evaluating the position of the patient's smile relative to a selected reference line of the maxillary base to obtain a desired position of an upper incisal edge represented by a lower surface of the anterior segment; and
if the position of the upper incisal edge is not satisfactory, connecting one of the shim members to the lower surface of the anterior segment and reevaluating the position of the patient's smile relative to another one of the reference lines of the maxillary base.

2. The method of claim 1, wherein if the position of the upper incisal edge is not satisfactory, connecting another one of the shim members to the shim member connected to the lower surface of the anterior segment and reevaluating the position of the patient's smile relative to another one of the reference lines of the maxillary base.

3. The method of claim 2, wherein the plurality of reference lines of the occlusal rim differs from one another, wherein each of the shim members has a reference line corresponding to one of the reference lines of the occlusal rim, and wherein the lower surface of the anterior segment corresponds with one of the reference lines of the occlusal rim.

4. The method of claim 1, wherein the anterior segment is pivotally connected to the maxillary base plate to allow the lower surface of the anterior segment to adjust horizontally, and wherein the step of evaluating the position of the anterior segment further comprises pivoting the anterior segment so the lower surface is horizontal.

5. The method of claim 1, further comprising:
making an interocclusal record with the maxillary base plate to create a second data set; and
using the second data set to create a final prosthesis.

6. A method of capturing fit and tooth position information for creating a full arch prosthesis, the method comprising:
obtaining a three-dimensional electronic model of a patient's maxillary and mandibular arch and measuring the patient's intra-oral anatomy and extra-oral anatomy to produce a first data set;
converting, by a computer processor, the first data set to a three-dimensional electronic model of a maxillary base plate with an occlusal rim and a mandibular base with an occlusal rim;
forming the maxillary base plate with the occlusal rim having an anterior segment, a pair of posterior segments, a plurality of horizontal reference lines vertically spaced relative to one another corresponding with the average length of the clinical crown of upper central incisors, and a plurality of shim members connectable to the anterior segment;
forming the mandibular base plate with the occlusal rim having an anterior segment, a pair of posterior segments, and a plurality of shim members connectable to the anterior segment of the mandibular base plate;
seating the maxillary base plate on the maxillary arch of the patient;
seating the mandibular base plate on the mandibular arch of the patient;
evaluating the fit of the maxillary base plate and, if not satisfactory, modifying the fit of the maxillary base plate;
evaluating the fit of the mandibular base plate and, if not satisfactory, modifying the fit of the maxillary base plate;
evaluating the position of the patient's smile relative to a selected reference line of the maxillary base to obtain a desired position of an upper incisal edge represented by a lower surface of the anterior segment; and
if the position of the upper incisal edge is not satisfactory, connecting one of the shim members to the lower surface of the anterior segment and reevaluating the position of the patient's smile relative to another one of the reference lines of the maxillary base.

7. The method of claim 6, wherein if the position of the upper incisal edge is not satisfactory, connecting another one of the shim members to the shim member connected to the lower surface of the anterior segment and reevaluating the position of the patient's smile relative to another one of the reference lines of the maxillary base.

8. The method of claim 7, wherein the plurality of reference lines of the occlusal rim differs from one another, wherein each of the shim members has a reference line corresponding to one of the reference lines of the occlusal rim, and wherein the lower surface of the anterior segment corresponds with one of the reference lines of the occlusal rim.

9. The method of claim 6, wherein the anterior segment is pivotally connected to the maxillary base plate to allow the lower surface of the anterior segment to adjust horizontally, and wherein the step of evaluating the position of the anterior segment further comprises pivoting the anterior segment so the lower surface is horizontal.

10. The method of claim 6 further comprising:
evaluating the position of the patient's smile relative to the anterior segment of the mandibular base plate to obtain a desired position of a lower incisal edge represented by an upper surface of the anterior segment of the mandibular base plate; and
if the position of the lower incisal edge is not satisfactory, connecting one of the shim members to the upper surface of the anterior segment of the mandibular base plate and reevaluating the position of the patient's smile relative to an upper surface of the shim member connected to the mandibular base plate.

11. The method of claim 10, wherein if the position of the lower incisal edge is not satisfactory, connecting another one of the shim members to the shim member connected to the upper surface of the anterior segment of the mandibular base plate and reevaluating the position of the patient's smile relative to an upper surface of the uppermost shim member connected to the mandibular base plate.

12. The method of claim 6, further comprising:
making an interocclusal record with the maxillary base plate to create a second data set; and
using the second data set to create a final prosthesis.
